(19) United States
(12) Patent Application Publication
(10) Pub. No.: US 2025/0321081 A1
(43) Pub. Date: Oct. 16, 2025

(54) ILLUMINATED RETICLE AIMING POINT

(71) Applicant: Sheltered Wings, Inc. d/b/a Vortex Optics, Barneveld, WI (US)

(72) Inventors: Christian Benson, Barneveld, WI (US); Joseph Heltemes, Barneveld, WI (US); Connor McDermot, Barneveld, WI (US)

(21) Appl. No.: 19/177,006

(22) Filed: Apr. 11, 2025

Related U.S. Application Data
(60) Provisional application No. 63/632,548, filed on Apr. 11, 2024.

(51) Int. Cl. F41G 1/34; G02B 23/10; G02B 23/14

(52) U.S. Cl. CPC F41G 1/345; G02B 23/105; G02B 23/14

(57) ABSTRACT

A system for illuminating a reticle in a field of view of a view-through optic. The system includes a light source, a coupling optical element, and a diffractive surface illuminated by the light produced by the light source.

### CROSS-REFERENCE TO RELATED APPLICATIONS

This application is a non-provisional patent application of and claims priority to U.S. Provisional Patent Application No. 63/632,548 filed Apr. 11, 2024, which is incorporated herein by reference in its entirety.

### FIELD

This disclosure relates generally to viewing optics. In one embodiment, this disclosure relates to an optical system that allows for an illuminated aiming point viewable through an optical path of a view-through optic.

### BACKGROUND

View-through optics used in the sporting industry, such as riflescopes, binoculars, spotting scopes, etc, can be improved by projecting information to the user's eye overlayed on the field of view. In particular, there is a desire to provide an illuminated center aiming point that is highly visible in all likely lighting conditions for shooting. One approach for providing an illuminated center aiming point is to run an optical fiber to the center of the field of view, usually supported by a metal wire reticle. However, the minimum size requirements of using optical fiber technology prohibits its use in the first focal plane. In addition, traditional use of optical fiber technology in the second focal plane does not allow for free floating aiming features. Additionally, use of optical fiber technology in the second focal plane may not meet the minimum size requirements needed in a view-through optic utilizing aiming features in both the first and second focal plane. In this case, the fiber size may block too much of the features in the first focal plane.

This disclosure relates to a system for providing an illuminated aiming point viewable through an optical path of a view-through optic by using a remote light source aimed at diffraction grating etched onto a glass substrate.

### SUMMARY

In one embodiment, the disclosure provides a viewing optic including a body with a first end and a second end and having a center axis. The viewing optic further includes an objective lens system disposed within the body, an eyepiece lens disposed within the body, and an erector lens system disposed within the body, wherein the objective lens system, eyepiece lens, and erector lens for an optical system having a first focal plane and a second focal plane. The viewing optic further includes a reticle system having a reticle, a light source optically attached to a coupling optical element, and a diffractive structure disposed on the reticle such that light produced by the light source passes through the coupling optical element and illuminates the diffractive structure.

In one embodiment of the viewing optic, the light source comprises a light emitting diode.

In one embodiment of the viewing optic, the optical element includes a refractive lens.

In one embodiment of the viewing optic, the optical element includes a total internal reflection lens.

In one embodiment of the viewing optic, the optical element includes a simultaneous multiple-surface lens.

In one embodiment of the viewing optic, the light source and coupling optical element are positioned to illuminate the diffractive structure directly.

In one embodiment of the viewing optic, the light source and coupling optical element are positioned to illuminate the diffractive structure through total internal reflection within the reticle.

In one embodiment of the viewing optic, the light source and coupling optical element are positioned to illuminate the diffractive structure through a top of the reticle. In one embodiment of the viewing optic, the top of the reticle may include features that assist in coupling light, e.g., an angled face cut into the top of the substrate.

In one embodiment of the viewing optic, the light source and coupling optical element are positioned to illuminate the diffractive structure through a back of the reticle.

In one embodiment of the viewing optic, the diffractive structure is transmissive.

In one embodiment of the viewing optic, the diffractive structure is reflective.

In one embodiment of the viewing optic, the diffractive structure comprises a diffraction grating.

In one embodiment of the viewing optic, the reticle is disposed in the first focal plane.

### BRIEF DESCRIPTION OF THE DRAWINGS

FIG. 1 is a perspective view of one embodiment of a viewing optic in accordance with the principles of this disclosure;

FIG. 2 is a cross-section view of the viewing optic of FIG. 1, taken generally along the line 2-2 showing a movable optical element inside the optic body;

FIG. 3 is a schematic view of the optical element of the viewing optic of FIG. 1;

FIG. 4 is a schematic section view of a reticle for the view-through optic of FIG. 1, including how a grating structure on the reticle may be illuminated in accordance with some principles of this disclosure;

FIG. 5 is a schematic view of one embodiment of a total internal reflection lens that may be used to direct light to the grating structure on the reticle in accordance with some principles of this disclosure;

FIG. 6 is a schematic view of one embodiment of a simultaneous multiple-surface (SMS) lens that may be used to direct light to the grating structure on the reticle in accordance with some principles of this disclosure; and

FIG. 7 is a schematic view of a plurality of embodiments of refraction lenses that may be used to direct light to the grating structure on the reticle in accordance with some principles of this disclosure.

It is to be understood that the disclosure is not limited in its application to the details of construction and the arrangement of the components set forth in the following description or illustrated in the drawings. The technology of this present disclosure is capable of other embodiments or being practiced or carried out in various ways. Also, it is to be understood that the phraseology and terminology employed herein is for the purpose of description and should not be regarded as limiting.

### DETAILED DESCRIPTION

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the disclosure to those skilled in the art.

It will be appreciated by those skilled in the art that the set of features and/or capabilities may be readily adapted within the context of a standalone weapons sight, front-mount or rear-mount clip-on weapons sight, and other permutations of filed deployed optical weapons sights. Further, it will be appreciated by those skilled in the art that various combinations of features and capabilities may be incorporated into add-on modules for retrofitting existing fixed or variable weapons sights of any variety.

It will be understood that when an element or layer is referred to as being “on”, “connected to” or “coupled to” another element or layer, it can be directly on, connected or coupled to the other element or layer. Alternatively, intervening elements or layers may be present. In contrast, when an element is referred to as being “directly on,” “directly connected to” or “directly coupled to” another element or layer, there are no intervening elements or layers present.

Like numbers refer to like elements throughout. As used herein, the term “and/or” includes any and all combinations of one or more of the associated listed items.

It will be understood that, although the terms first, second, etc. may be used herein to describe various elements, components, regions, and/or sections, these elements, components, regions, and/or sections should not be limited by these terms. These terms are only used to distinguish one element, component, region, or section from another element, component, region, or section. Thus, a first element, component, region, or section discussed below could be termed a second element, component, region, or section without departing from the disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

Any numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target or from one component of a device to another component of a device.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “viewing optic” refers to an apparatus used by a shooter or a spotter to select, identify or monitor a target. The “viewing optic” may rely on visual observation of the target, or, for example, on infrared (IR), ultraviolet (UV), radar, thermal, microwave, or magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to the shooter by the “viewing optic” device may be unaltered, or it may be enhanced, for example, by magnification, amplification, subtraction, superimposition, filtration, stabilization, template matching, or other means. The target selected, identified or monitored by the “viewing optic” may be within the line of sight of the shooter, or tangential to the sight of the shooter, or the shooter's line of sight may be obstructed while the target acquisition device presents a focused image of the target to the shooter. The image of the target acquired by the “viewing optic” may be, for example, analog or digital, and shared, stored, archived, or transmitted within a network of one or more shooters and spotters by, for example, video, physical cable or wire, IR, radio wave, cellular connections, laser pulse, optical, 802.11b or other wireless transmission using, for example, protocols such as html, SML, SOAP, X.25, SNA, etc., Bluetooth™, Serial, USB or other suitable image distribution method. The term “viewing optic” is used interchangeably with “optic sight.”

As used herein, the term “shooter” applies to either the operator making the shot or an individual observing the shot in collaboration with the operator making the shot.

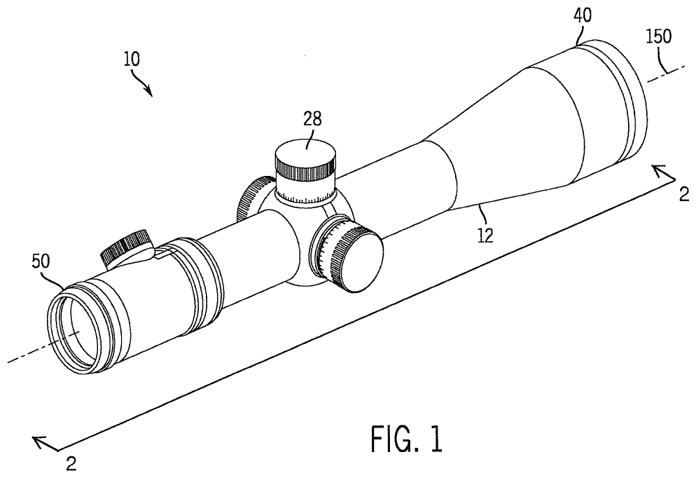

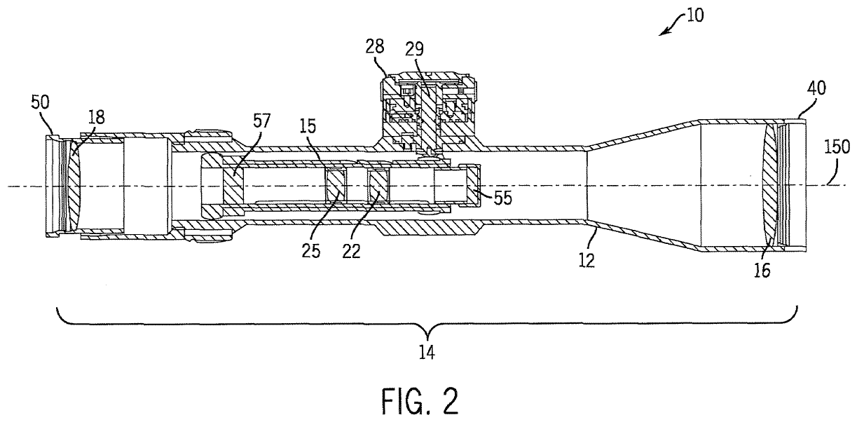

FIG. 1 shows an exemplary viewing optic 10, having a scope body 12, objective lens end 40 and ocular end 50. FIG. 2 shows a cross-section of the sighting device from FIG. 1 showing the basic components of optical system 14 and moveable optical element 15. As shown in FIG. 2, optical system 14 includes an objective lens system 16, erector system 25, and eyepiece 18. FIG. 2 shows a riflescope having a body 12, but optical system 14 could be used in other types of sighting devices as well. Erector system 25 may be included within a moveable optic element 15. In FIG. 2, moveable optic element 15 also includes a collector 22, as well as first focal plane reticle 55 and second focal plane reticle 57. When in use, adjustment of turret assembly 28 and turret screw 29 causes adjustment of moveable optic element 15.

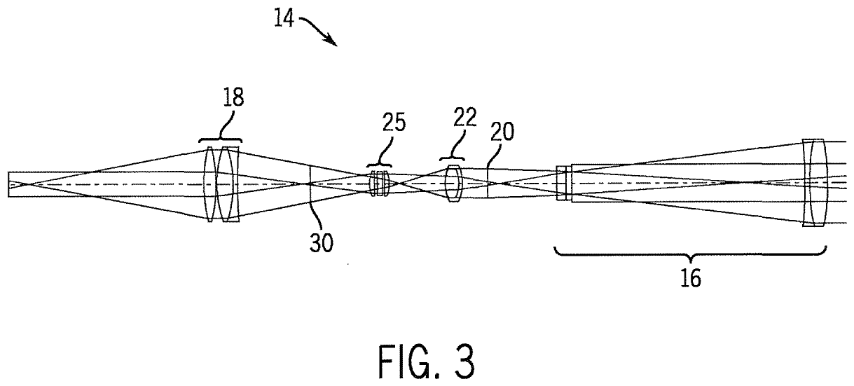

FIG. 3 shows an optical system 14 in cross-section, illustrating how light rays travel through the optical system 14. Optical system 14 may have additional optical components such as collector 22, and it is well known within the art that certain components, such as objective lens system 16, erector system 25, and eyepiece 18 may themselves have multiple components or lenses. Optical system 14 shown here is drawn as a basic system for illustration of one embodiment of an illuminated reticle aiming point in accordance with the principles of this disclosure, but it should be understood that variations of other optical systems with more or less structural components would be within the scope of the disclosure as well.

In one embodiment, the disclosure relates to a viewing optic with a reticle system having a transparent substrate etched with a desired pattern, e.g. crosshairs, and a fiber optic reticle coupled to the transparent substrate. In one embodiment, the reticle system can be in the first focal plane or the second focal plane. In one embodiment, the viewing optic may have a reticle system in both the first focal plane and the second focal plane.

In one embodiment, the transparent substrate has a first side facing the objective lens and a second side facing the ocular lens. In one embodiment, the transparent substrate has an objective facing side and an ocular facing side. In one embodiment, in addition to the objective facing side and ocular facing side, there is a plane within the substrate that has been connected via optical cement.

In one embodiment, the first side of the transparent substrate has a marking pattern or reticle useful for the user/shooter of the viewing optic. In another embodiment, the second side of the transparent substrate has a marking pattern or reticle useful for the user/shooter of the viewing optic. In another embodiment, the plane within the transparent substrate has a marking pattern or reticle useful for the user/shooter of the viewing optic.

In one embodiment, the marking pattern or reticle is on the objective side of the transparent substrate. In yet another embodiment, the marking pattern or reticle is on the ocular side of the transparent substrate. In another embodiment, the marking pattern or reticle is contained within transparent substrate. In one embodiment, the marking pattern or reticle is applied by any suitable method including but not limited to etching, engraving, and chromium deposit.

In one embodiment, the transparent substrate is a glass substrate including but not limited to crown glass, e.g. Schott® high transparent crown glass B270 or Schott® bor-crown glass BK7. transparent plastics, and polycarbonate.

In one embodiment, the glass reticle can be etched with any desired pattern including but not limited to numbers, dots and other floating features. In one embodiment, the transparent substrate has a full and complete reticle pattern. In yet another embodiment, the glass substrate has a full and complete reticle pattern and can function independent of any other markings.

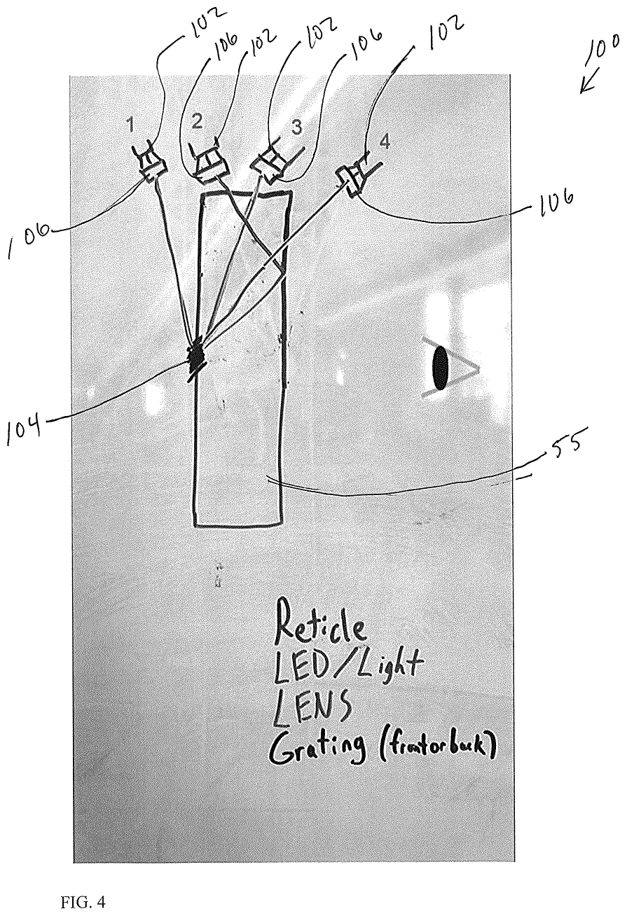

Turning now to FIG. 4, one embodiment of a system 100 for illuminating a reticle aiming point is shown. In one embodiment, system 100 includes an LED light source 102 optically attached to a coupling system that directs light generated by the LED to a diffractive structure 104 on the first focal plane reticle 55. The diffractive structure 104 may be formed by modifying the surface geometry of the glass substrate of the first focal plane reticle 55. This diffractive structure 102 allows light to be directed towards the user much more efficiently than a reflective surface in a standard glass reticle. In certain embodiments, diffractive structure 102 comprises a diffraction grating or any other suitable diffractive optical element. In some embodiments, diffractive structure 102 may be reflective. In some embodiments, diffractive structure 102 may be transmissive. In certain embodiments, system 100 reduces the cost to manufacture the viewing optic 10 and improves battery life, maximum brightness, and stray light control. Cost reduction generally comes from the ease of manufacturing and assembly.

In some embodiments, system 100 can be used to design a more efficient and easier to manufacture a first focal plane reticle 55 that has an illuminated aiming point that is bright enough to be seen in bright daylight. Of course, system 100 may alternatively be used with second focal plane reticle 57 without departing from the principles of this disclosure.

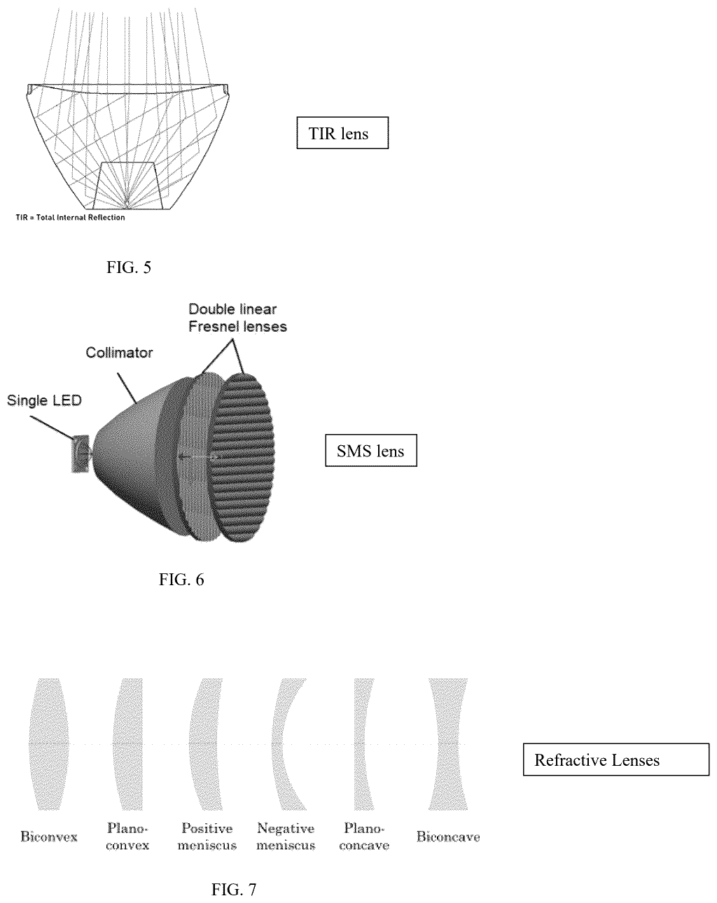

Continuing with FIG. 4, a schematic view showing four positions for the LED light source 104 in relation to the reticle 55 is shown. As shown, the LED light source 104 is positioned such that light emitted from the LED passes through a coupling optical element 106 that directs the light to the diffractive structure 102. As shown in FIG. 5, the coupling optical element 106 may be one or more lenses of any of a refractive lens, total internal reflection (TIR) lens, and simultaneous multiple-surface (SMS) lens. Notably, system 100 does not include a prism, retroreflector, or other component besides LED light source 104 and coupling optical element 106.

In the schematic shown in FIG. 4, LED light source 104 and coupling optical element 106 are shown in four possible positions such that: (401) the LED directly illuminates the diffractive structure 102 of reticle 55, (402) the LED illuminates the diffractive structure through total internal reflection within the reticle, (403) the LED illuminates the diffractive structure through the top of the reticle, or (404) the LED illuminates the diffractive structure through the back of the reticle. Of course, alternative arrangements of the LED light source 104, coupling optical element 106, diffractive structure 102, and reticle 55 may be used without departing from the principles of this disclosure.

FIG. 6 is a schematic view of one embodiment of a simultaneous multiple-surface (SMS) lens that may be used to direct light to the grating structure on the reticle.

FIG. 7 is a schematic view of a plurality of embodiments of refraction lenses that may be used to direct light to the grating structure on the reticle.

While various embodiments have been described in detail, it should be apparent that modifications and variations thereto are possible, all of which fall within the true spirit and scope of the disclosure. With respect to the above description then, it is to be realized that the optimum dimensional relationships for the parts of the disclosed technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure. Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

What is claimed is:

1. A viewing optic comprising:
a body with a first end and a second end and having a center axis;
an objective lens system disposed within the body;
an eyepiece lens disposed within the body;
an erector lens system disposed within the body;
the objective lens system, eyepiece lens, and erector lens system forming an optical system having a first focal plane and a second focal plane; and
a reticle system having a reticle, a light source optically attached to a coupling optical element, and a diffractive structure disposed on the reticle such that light produced by the light source passes through the coupling optical element and illuminates the diffractive structure.

2. The viewing optic of claim 1, wherein the light source is a light emitting diode.

3. The viewing optic of claim 1, wherein the optical element comprises a refractive lens.

4. The viewing optic of claim 1, wherein the optical element comprises a total internal reflection lens.

5. The viewing optic of claim 1, wherein the optical element comprises a simultaneous multiple-surface lens.

6. The viewing optic of claim 1, wherein the light source and coupling optical element are positioned to illuminate the diffractive structure directly.

7. The viewing optic of claim 1, wherein the light source and coupling optical element are positioned to illuminate the diffractive structure through total internal reflection within the reticle.

8. The viewing optic of claim 1, wherein the light source and coupling optical element are positioned to illuminate the diffractive structure through a top of the reticle.

9. The viewing optic of claim 1, wherein the light source and coupling optical element are positioned to illuminate the diffractive structure through a back of the reticle.

10. The viewing optic of claim 1, wherein the diffractive structure is transmissive.

11. The viewing optic of claim 1, wherein the diffractive structure is reflective.

12. The viewing optic of claim 1, wherein the diffractive structure comprises a diffraction grating.

13. The viewing optic of claim 1, wherein the reticle is disposed in the first or second focal plane.

14. A reticle illumination system comprising;
a reticle,
a light source optically attached to a coupling optical element, and
a diffractive structure disposed on the reticle such that light produced by the light source passes through the coupling optical element and illuminates the diffractive structure.

15. The reticle illumination system of claim 14, wherein the light source is a light emitting diode.

16. The reticle illumination system of claim 14, wherein the coupling optical element comprises one of a refractive lens, a total internal reflection lens, or a simultaneous multiple-surface lens.

17. The reticle illumination system of claim 14, wherein the light source and coupling optical element are positioned to illuminate the diffractive structure directly.

18. The reticle illumination system of claim 14, wherein the light source and coupling optical element are positioned to illuminate the diffractive structure through total internal reflection within the reticle.

19. The reticle illumination system of claim 14, wherein the light source and coupling optical element are positioned to illuminate the diffractive structure through a top of the reticle.

20. The reticle illumination system of claim 14, wherein the light source and coupling optical element are positioned to illuminate the diffractive structure through a back of the reticle.
